(19) United States
(12) Patent Application Publication
(10) Pub. No.: US 2018/0355644 A1
(43) Pub. Date: Dec. 13, 2018

(54) Latch Assembly for Vehicle Trunk Door

(71) Applicant: WOOBO TECH CO., LTD., Pyeongtaek-si, Gyeonggi-do (KR)

(72) Inventor: Hae Il Jeong, Incheon (KR)

(21) Appl. No.: 15/778,885

(22) PCT Filed: Dec. 20, 2016
(86) PCT No.: PCT/KR2016/014933

§ 371 Date: May 24, 2018

(30) Foreign Application Priority Data
Dec. 28, 2015 (KR) 10-2015-0187263

(51) Int. Cl. E05B 83/18; E05B 81/14; E05B 81/20; E05B 81/68; E05B 81/36

(52) U.S. Cl. CPC E05B 83/18; E05B 81/14; E05B 81/90; E05B 81/68; E05B 81/36; E05B 81/20

(57) ABSTRACT

The present invention relates to a latch assembly for a vehicle trunk door, and more particularly to a latch assembly for a vehicle trunk door wherein the rotating axis of the main gear of the driving unit is disposed on the same axial line of the rotating axis of the main latch so that the device becomes compact and the number of components is also reduced as well.

### TECHNICAL FIELD

The present invention relates to a latch assembly for a vehicle trunk door, and more particularly to a latch assembly for a vehicle trunk door wherein the rotating axis of the main gear of the driving unit is disposed on the same axial line of the rotating axis of the main latch.

### BACKGROUND ART

A trunk lid latch which controls the opening and closing the trunk lid is operated by driving the actuator separately installed from the latch or manipulating the key box installed outside of the trunk lid.

Furthermore, a number of gears must be provided in order to transfer the driving force from the actuator to the latch, therefore, there is a problem that the volume of the device becomes large due to such a number of gears and the number of components increases as well.

### LEADING TECHNICAL LITERATURES

### Patent Literature

[Patent Literature 1] Korea Utility Patent Publication No. 1998-048786

### DISCLOSURE OF INVENTION

### Technical Problem

An objective of the present invention devised for solving the above mentioned problems, is to provide a latch assembly for a vehicle trunk door which is compact in size, simple in structure and has a fewer number of components, thereby reducing the manufacturing cost.

### Solution to Problem

To achieve above described objective, the latch assembly for a vehicle trunk door of the present invention is characterized in that and comprises: a housing installed in the trunk door; a main latch rotatably installed in the housing; a locking member installed in the housing for locking the main latch; and a driving unit installed in the housing for closing or opening the trunk door, wherein the driving unit comprises: a motor; and a main gear being rotated by the motor, and wherein the rotating axis of the main gear of the driving unit is disposed on the same axial line of the rotating axis of the main latch.

The driving unit is capable of closing the trunk door and opening the trunk door.

A holding unit rotating the main latch can be formed in the main gear.

An unlock link wherein a first holding part rotatably installed in the housing for rotating the locking member is further included, and the locking member is rotatably installed in the housing and the unlock link is rotated by the main gear.

The locking member is rotatably installed in the housing, wherein an unlock link formed with a first holding part rotatably installed in the housing and rotating the locking member and a second holding part disposed spaced apart from the first holding part towards the circumferential direction is further included, and an auxiliary link rotatably installed in the housing and rotated by the second holding part is further include, and wherein the holding unit is rotatably formed in the main gear, and the auxiliary link separates the holding unit from the main latch, and the unlock link is rotated by the main gear.

The motor and the main gear can be connected through a first worm, a first worm gear gearing with the first worm, a second worm installed in the first worm gear, and the main gear gearing with the second worm.

A third sensor detecting the position of the main gear is further included, wherein a sensor pressing element pressing the third sensor is formed in the main gear, and the motor can be controlled by a control unit using the signal transferred from the third sensor.

### Advantageous Effects of Invention

As described above, according to a latch assembly for a vehicle trunk door of the present invention, there are advantageous effects as follows.

Since the rotating axis of the main gear of the driving unit is disposed on the same axial line of the rotating axis of the main latch, the device becomes compact and the number of the components is reduced as well.

Since the driving unit can close and open the trunk door at the same time, the door can be closed and opened automatically by using a single driving unit at the same time.

The motor and the main gear are connected through a first worm, a first worm gear gearing with the first worm, a second worm installed in the first worm gear, and the main gear gearing with the second worm, so that the reduction can be performed smoothly with a simple structure and the device becomes more compact as well.

The unlock link rotating the locking member is rotated by the main gear so that the door can be opened automatically.

A third sensor detecting the position of the main gear is further included, the control unit controls the motor using the signal transferred from the third sensor so that the main gear can be smoothly returned to the basic position (the position enabling the manual opening of the door through the lever member in an emergency situation).

### BRIEF DESCRIPTION OF DRAWINGS

FIG. 1 is a front perspective view of a latch assembly for a vehicle trunk door according to a preferred exemplary embodiment of the present invention.

FIG. 2 is a perspective view wherein the outer cover is removed from a latch assembly for a vehicle trunk door according to a preferred exemplary embodiment of the present invention.

FIG. 3 is an exploded perspective view of a latch assembly for a vehicle trunk door according to a preferred exemplary embodiment of the present invention.

FIG. 4 is a front perspective view (above) and a rear perspective view (below) of an outer cover of a latch assembly for a vehicle trunk door according to a preferred exemplary embodiment of the present invention.

FIG. 5 is a front perspective view (above) and a rear perspective view (below) of a bracket of a latch assembly for a vehicle trunk door according to a preferred exemplary embodiment of the present invention.

FIG. 6 is a front perspective view of an inner cover of a latch assembly for a vehicle trunk door according to a preferred exemplary embodiment of the present invention.

FIG. 7 is a front perspective view of a main latch of a latch assembly for a vehicle trunk door according to a preferred exemplary embodiment of the present invention.

FIG. 8 is an exploded perspective view of a driving unit of a latch assembly for a vehicle trunk door according to a preferred exemplary embodiment of the present invention.

FIG. 9 is a front perspective view of a locking member of a latch assembly for a vehicle trunk door according to a preferred exemplary embodiment of the present invention.

FIG. 10 is a front perspective view of a lever member and a cable of a latch assembly for a vehicle trunk door according to a preferred exemplary embodiment of the present invention.

FIG. 11 is a front perspective view of an unlock link of a latch assembly for a vehicle trunk door according to a preferred exemplary embodiment of the present invention.

FIG. 12 is a front perspective view of an auxiliary link of a latch assembly for a vehicle trunk door according to a preferred exemplary embodiment of the present invention.

FIG. 13 is partial perspective views illustrating the process of door opening of a latch assembly for a vehicle trunk door according to a preferred exemplary embodiment of the present invention (metal portion is removed from the main gear).

FIG. 14 is partial perspective views illustrating the first process of the door closing of a latch assembly for a vehicle trunk door according to a preferred exemplary embodiment of the present invention (metal portion is removed from the main gear).

FIG. 15 is partial perspective views illustrating the second process of the door closing of a latch assembly for a vehicle trunk door according to a preferred exemplary embodiment of the present invention (metal portion is removed from the main gear).

FIG. 16 is partial perspective views illustrating the third process of the door closing of a latch assembly for a vehicle trunk door according to a preferred exemplary embodiment of the present invention (metal portion is removed from the main gear).

FIG. 17 is a partial perspective view illustrating the process of door opening by using a lever or a cable in an emergency state in a latch assembly for a vehicle trunk door according to a preferred exemplary embodiment of the present invention (metal portion is removed from the main gear).

FIG. 18 is a partial perspective view illustrating the process of door closing of a latch assembly for a vehicle trunk door according to a preferred exemplary embodiment of the present invention.

FIG. 19 is a partial perspective view illustrating the first process of door opening by using a motor of a latch assembly for a vehicle trunk door according to a preferred exemplary embodiment of the present invention.

FIG. 20 is a partial perspective view illustrating the second process of door opening by using a motor of a latch assembly for a vehicle trunk door according to a preferred exemplary embodiment of the present invention.

FIG. 21 is a partial perspective view illustrating the third process of door opening by using a motor of a latch assembly for a vehicle trunk door according to a preferred exemplary embodiment of the present invention.

### MODE FOR THE INVENTION

Hereinafter, a preferred exemplary embodiment of the present invention will be described in detail with reference to the accompanying drawings as follows.

For reference, for the components of the present invention which will be described hereinafter and identical to those of the prior art, separate detailed descriptions will be omitted, but instead will be referred the prior art described above.

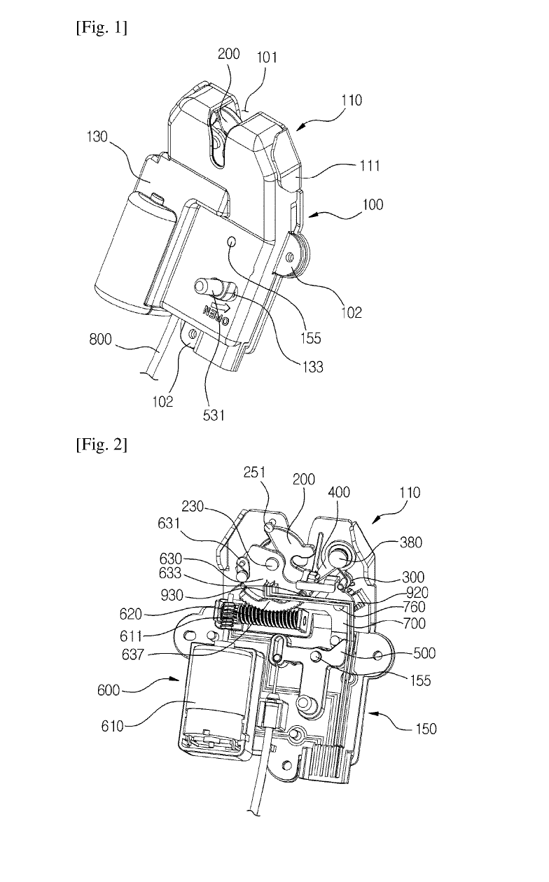

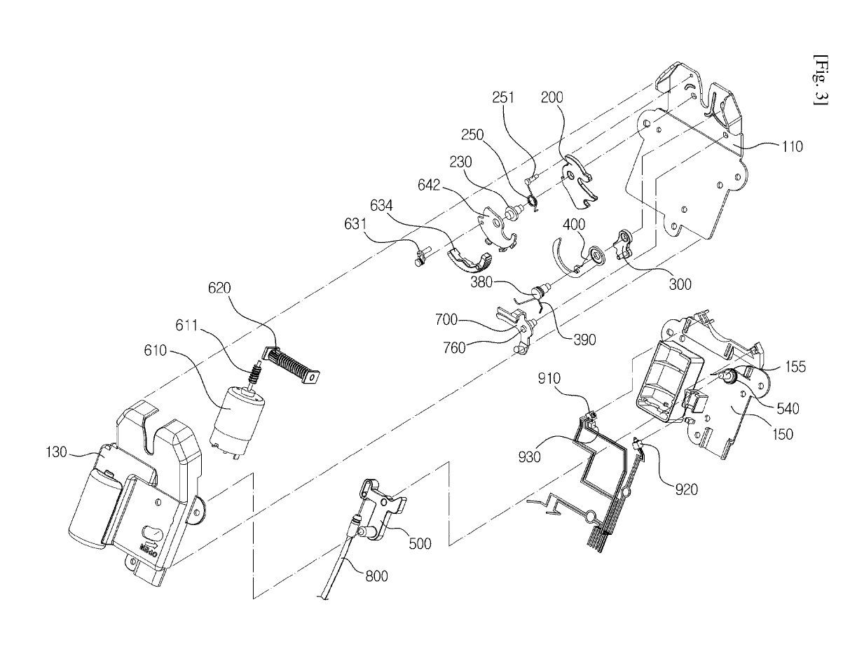

As illustrated in FIGS. 1 to 21, a latch assembly for a vehicle trunk door according to an exemplary embodiment is characterized in that and comprising: a housing 100 installed in the trunk door; a main latch 200 rotatably installed in the housing 100; a locking member 300 installed in the housing 100 for locking the main latch 200; and a driving unit 600 installed in the housing 100 for closing or opening the trunk door.

As illustrated in FIG. 1, in the housing 100, the front means the direction towards the outer cover 130, and the rear side means direction towards the bracket 110. In addition, the left side and the right side described hereinafter mean the left side and the right side viewing from the front. The left side and the right side, used when describing the members formed in the rear side surface, also mean the left side and the right side viewing from the front of the members.

As illustrated in FIGS. 1 to 3, the housing 100 comprises: an outer cover 130 disposed in the front side; a bracket 110 disposed in the rear direction; and an inner cover 150 disposed between the outer cover 130 and the bracket 110.

In the upper side of the housing 100, and in the upper side of the outer cover 130 and the bracket 110, a striker insertion slot 101 wherein the striker 10 is inserted is formed in a way that the upper side, the front side, and the rear side thereof are open.

Also, fastening elements 102 are outwardly formed respectively in the left side, the right side, and the lower side in the peripheries of the outer cover 130, the bracket 110, and the inner cover 150.

Fastening holes wherein bolts are fastened are formed in the fastening elements 102.

The latch assembly for a vehicle trunk door is installed in the trunk door through such fastening elements 102. The fastening elements 102 are formed plurally as those of the present exemplary embodiment, and fastening holes of at least one fastening element 102 of the fastening elements 102 are formed to be the shape of an elongated hole so that the installation tolerance can be allowed.

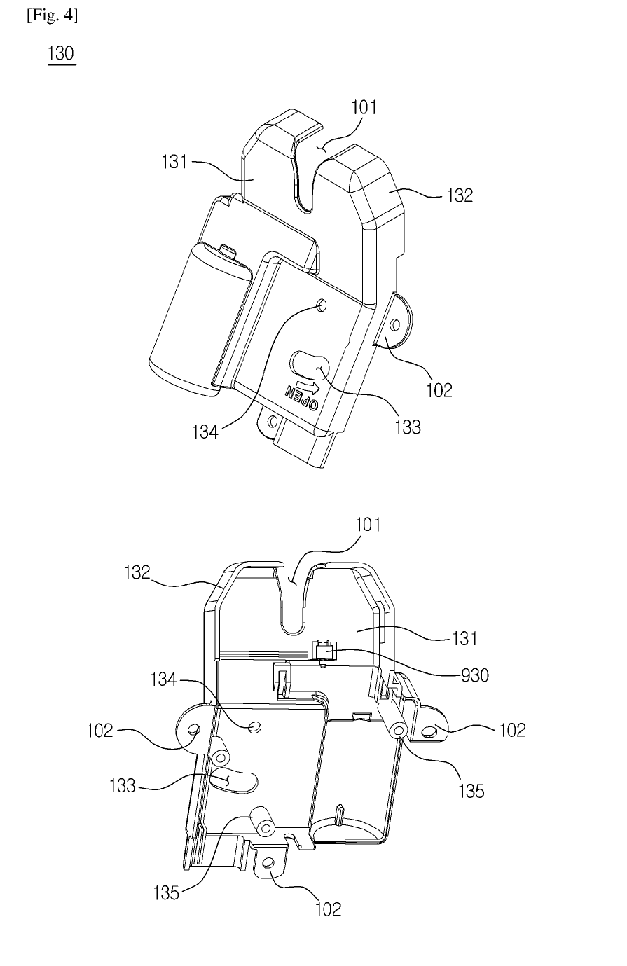

As illustrated in FIG. 4, the upper portion of the outer cover 130 is formed to be slanted.

The outer cover 130 comprises: a front plate 131; and a side plate 132 formed in the circumference of the front plate 131. The fastening elements 102 are formed in the rear end of the side plate 132.

In the right side of the outer cover 130, a lever member shaft insertion hole 134 is penetratingly formed along the front-to-rear direction.

In the lower right portion of the outer cover 130, an aperture 133 is penetratingly formed along the front-to-rear direction.

In the front surface of the outer cover 130, the direction of door opening is marked with an arrow and letters.

In the lower right portion of the outer cover 130, an electrical wire withdrawing port from where the electrical wire connected to the component of the latch assembly for a vehicle trunk door is withdrawn is formed.

In the lower middle portion of the outer cover 130, a cable withdrawing port from where a cable 800 is withdrawn is formed.

In the rear surface of the outer cover 130, the outer cover 130, the bracket 110, and assembly fastening elements 135, wherein the bolts for fastening the outer cover 130, the bracket 110, and the inner cover 150 are fastened, are formed.

The assembly fastening elements 135 are respectively formed in the right middle portion, right lower portion, and left middle portion of the non-slanted rear surface of the outer cover 130.

The outer cover 130 can be formed with a plastic material.

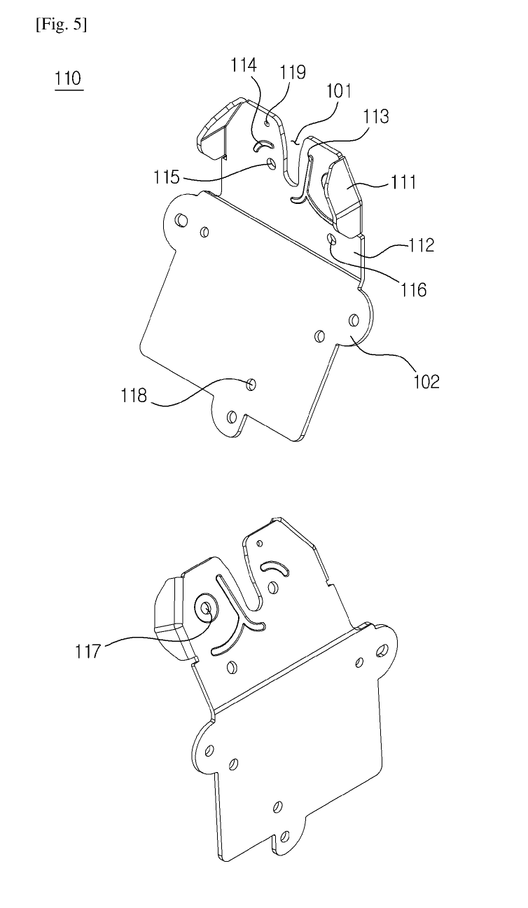

As illustrated in FIG. 5, the bracket 110 can be formed with a metal which is stronger than the plastic.

The bracket 110 is formed with a plate material, and a rear slanted portion 112 is formed in the upper side thereof. The rear slanted portion 112 is formed by bending the upper portion of the bracket 110 towards the front.

Bended plates 111 forwardly bended are formed in the both sides of the upper portion of the slanted portion 112.

The bended plates 111 are disposed in the outer sides of the side plate 132. Due to such bended plates 111 the temporary assembling becomes easier.

In the slanted portion 112, a latch shaft insertion hole 115 wherein the latch shaft 230, which will be described later, is inserted is penetratingly formed along the front-to-rear direction. The latch shaft insertion hole 115 is disposed at the left side of the striker insertion slot 101.

In the slanted portion 112, a locking member insertion hole 117 wherein a locking member shaft 380, which will be described later, is inserted is penetratingly formed along the front-to-rear direction. The locking member insertion hole 117 is disposed at the right side of the striker insertion slot 101.

In the slanted portion 112, a first protruded element 113 and a second protruded element 114 are formed forwardly protruded from around the peripheries of the locking member shaft insertion hole 117 and the latch shaft insertion hole 115. The first protruded element 113 and the second protruded element 114 are formed more forwardly protruded than the other area of the slanted portion 112.

The first protruded element 113 is contacted to the rear surface of a main latch 200, which will be described later, and the rear surface of the locking member 300. Thus, the main latch 200 and the locking member 300 will not be moved along the front-to-rear direction, and at the same time, the friction between the main latch 200 and the locking member 300 and the bracket 110 can be minimized. That is, since forwardly protruded portions are formed in the front surface of the bracket 110, the friction with the members rotating against the bracket 110 can be minimized. The first protruded element 113 is formed to have a shape similar to letter “l”. The first protruded element 113 is curvedly formed along the direction of rotation of the latch 200 and the locking member 300.

The second protruded element 114 is formed in the shape of an arc in the peripheral area of the latch shaft insertion hole 115, and contacted to the rear surface of the main latch 200.

In the slanted portion 112, an unlock link shaft insertion hole 116 wherein an unlock link shaft 760, which will be described later, is inserted is penetratingly formed along the front-to-rear direction. The unlock link shaft insertion hole 116 is disposed in the lower side of the locking member shaft insertion hole 117.

In the upper portion of the slanted portion 112, a spring holding shaft insertion hole 119 wherein a main latch spring holding shaft 251, which will be described later, is penetratingly formed along the front-to-rear direction. The spring holding shaft insertion hole 119 is disposed in the upper side of the latch shaft insertion hole 115.

Assembly fastening holes 118 are penetratingly formed along the front-to-rear direction in the left portion, the right portion, and the lower portion of the non-slanted portion of the bracket 110. The assembly fastening holes 118 and the assembly fastening elements 135 are fastened with assembling bolts, thereby completing the assembling of the device.

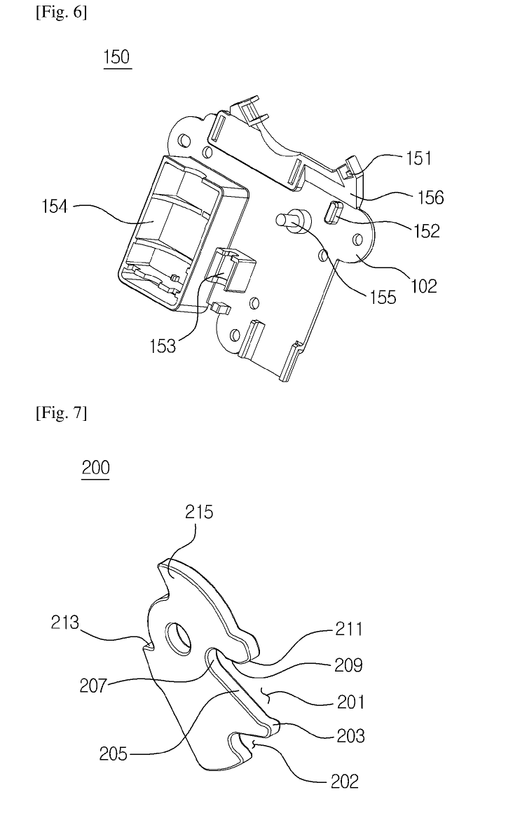

As illustrated in FIG. 6, the inner cover 150 is formed in the shape of a plate and disposed in the lower front side of the bracket 110.

In the upper side of the inner cover 150, a slanted portion 156 is formed. The slanted portion 156 is formed to be small so as to cover only a part of the slanted portion 112 of the bracket 110.

The inner cover 150 is made of a plastic material, and can be formed through the injection molding and the like. Thus, the inner cover 150 can be formed to have a complicated form easily.

A motor receiving slot 154 wherein a motor 610, which will be described later, is received is formed in the lower left side of the front surface of the inner cover 150. The motor receiving slot 154 is formed to have an open front.

In the front surface of the inner cover 150, a cable receiving part 153 wherein a cable 800, which will be described later, is received is formed. The cable receiving part 153 is formed to have an open front.

In the lower right side of the front surface of the inner cover 150, a withdrawing guide portion is formed for a smooth withdrawing of the electrical wire.

Also, the electrical wire is inserted into the inner cover 150. Due to this, the electrical wire can be protected, and the assembling process becomes easy since the electrical wire is not exposed externally.

In the right upper side of the front surface of the inner cover 150, a lever member shaft 155 is integrally formed so that the lever member shaft 155 is forwardly protruded.

In the right upper side of the front surface of the inner cover 150, a stopper element 152 is formed long in length along the up-down direction and forwardly protruded. The stopper element 152 is disposed in the upper right side of the lever member shaft 155.

In the both sides of the upper side of the slanted portion 156, sensor receiving slots 151 are formed. The sensor receiving slots 151 are formed to have open upper sides and open front sides.

Also, in the inner cover 150, intermediate assembly fastening holes communicating with the corresponding assembly fastening holes 118 are penetratingly formed along the front-to-rear direction.

The main latch 200 is installed inside the housing 100.

The main latch 200 is rotatably installed in the bracket 110 through the latch shaft 230 installed in the bracket 110.

As illustrated in FIG. 7, the main latch 200 is formed in the shape of a plate.

A locking slot 201 is formed in the outer circumferential surface of the main latch 200.

The width of the locking slot 201 is getting wider as it travels from the inside towards the outside.

The locking slot 201 is surrounded by: a first surface 203 formed to be flat; a second surface 205 extended from the left end of the first surface 203 and slantly formed; a third surface 207 extended from the left end of the second surface 205 and formed to be the shape of an arc so as to surround the striker 10; a fourth surface 209 extended from the upper right end of the third surface 207; and a fifth surface 211 extended from the right end of the fourth surface 209 and slantly formed.

The locking slot 201 is penetrating along the front-to-rear direction, and formed to have an open outer end side.

In the main latch 200, an auxiliary locking slot 202 is formed in the lower side of the locking slot 201.

The auxiliary locking slot 202 is formed to be similar to the locking slot 201 but having a depth smaller than the locking slot 201.

A spring insertion portion 213 is formed in the outer circumferential surface of the main latch 200.

The spring insertion portion 213 can be formed in the shape of a slot or a hole.

In the main latch 200, a protrusion 215 is formed outwardly protruded in the left side of the outer circumferential surface.

The locking slot 201, the auxiliary locking slot 202, the spring insertion portion 213, and the protrusion 215 are sequentially disposed in accordance with the rotating direction (clockwise) of the main latch 200 when the door is closing.

A main latch return spring 250 is provided for automatic returning of the main latch 200 when the locking is released.

The main latch return spring 250 is disposed in the front side of the main latch 200.

The one end of the main latch return spring 250 is caught in the main latch spring holding shaft 251 of the bracket 110, the middle portion is wound around the latch shaft 230, and the other end is inserted in the spring insertion portion 213.

Thus, when the main latch 200 is rotated, the other end of the main latch return spring 250 can be rotated together with the main latch 200.

The driving unit 600 rotates the main latch 200, and it is installed inside the housing 100.

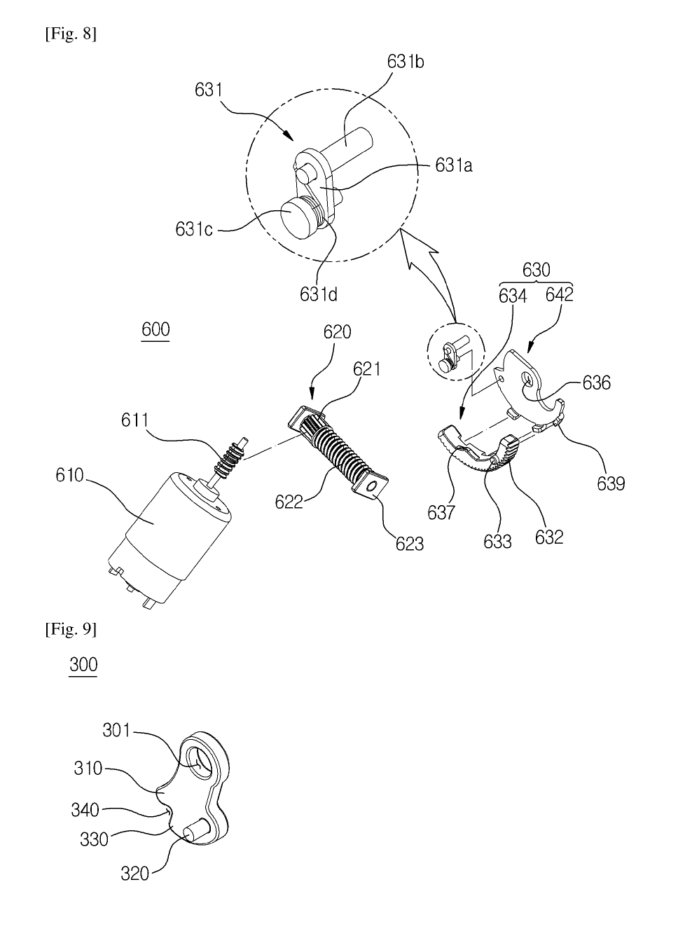

As illustrated in FIG. 8, the driving unit 600 comprises: a motor 610; a reduction gear 620 rotated by the motor 610; and a main gear 630 gearing with the reduction gear 620 and being rotated.

The driving unit 600 is installed in the front surface of the inner cover 150 and in the rear surface of the outer cover 130.

The driving unit 600 is disposed at the left lower side of the housing 100.

The shaft of the driving unit 600 is disposed along the up-down direction.

A first worm 611 is installed in the shaft of the motor 610.

The reduction gear 620 comprises: a first worm gear 621 gearing with the first worm 611; and a second worm 622 installed in the first worm gear 621.

The shaft of the reduction gear 620 is disposed along the left-to-right direction. The first worm gear 621 is disposed in the left side of the second worm 622, and it is integrally formed.

Thus, when the motor 610 operates, the first worm 611 is rotated, and as the first worm 611 is rotated the first worm gear 621 is rotated, and when the first worm gear 621 is rotated the second worm 622 integrally formed in the first worm gear 621 is rotated, and as the second worm 622 is rotated the main gear 630 is rotated.

The shaft of the reduction gear 620 is rotatably installed in shaft supporting plates 623. The shaft supporting plates 623 are respectively disposed in the left and the right sides of the reduction gear 620. Supporting plate insertion slots are respectively formed in the rear surface of the outer cover 130 and in the front surface of the inner cover 150 so that the reduction gear 620 can be easily installed in the housing 100.

When such reduction gear 620 is provided, the speed of the motor 610 is significantly reduced so that the driving is smoothly performed when the door is closed using the motor 610, and also the driving torque is obtained. Also, the speed is reduced when the door is closed so that the door can be urgently opened when a safety accident like jamming of a body part or clothing in the door occurs.

The main gear 630 is driven by the second worm gear, and receives the driving force of the motor 610 via the reduction gear 620.

The main gear 630 is disposed in the upper side of the reduction gear 620.

The main gear 630 is disposed in the front side of the main latch 200.

The main gear 630 is rotated centered around a latch shaft 230 disposed along the front-to-rear direction.

In the outer circumferential surface of the latch shaft 230, a separation plate disposed between the main latch 200 and the main gear 630 is formed.

A geared portion formed with gear teeth 632 is formed in one portion of the outer circumferential surface of the main gear 630, and in the remaining portion of the outer circumferential surface, a non-geared portion without gear teeth 632 is formed.

The geared portion is formed only in a part of the lower portion of the main gear 630.

The non-geared portion is formed in the remaining portion of the main gear 630 not in the geared portion. The non-geared portion is formed to be flat or curved.

The non-geared portion is formed in a metal portion 642 which will be described later.

That is, the gear teeth 632 of the main gear 630 are not formed in the entire circumference but formed only in a portion thereof. Therefore, the front-to-rear thickness and the total size can be reduced while maintaining the durability of the main gear 630.

The front-to-rear thickness of the geared portion is formed to be thicker than the thickness of the non-geared portion. Thus, the durability of the geared portion can be enhanced.

The main gear 630 comprises a plastic portion 634 and a metal portion 642 inserted into the plastic portion 634. The main gear 630 is formed by inserting the metal portion 642 into the plastic portion 634.

The plastic portion 634 is formed in the shape of an arc, and gear teeth 632 are formed in the outer circumferential surface thereof. The plastic portion 634 is more forwardly protruded than the metal portion 642.

In the right front surface of the plastic portion 634, a fourth unlock link holding element 633 is formed forwardly protruded. The fourth unlock link holding element 633 is formed in the shape of a cylinder.

In the plastic portion 634, a sensor pressing element 637 pressing a third sensor 930, which will be described later, is formed upwardly protruded in the opposite surface with respect to the surface formed with gear teeth 632. The both sides of the sensor pressing element 637 are formed to be slanted. The sensor pressing element 637 is disposed in the left side of the fourth unlock link holding element 633.

The metal portion 642 comprises: a plate portion having the shape of a plate; and a plurality of protruded portions 639 formed forwardly protruded in the circumference of the plate portion.

The plate portion is curvedly formed so as not to be interfered with the neighboring members when rotating. In the center area of the plate portion, a shaft insertion hole 636 wherein the latch shaft 230 is inserted is penetratingly formed along the front-to-rear direction.

The protruded portions 639 are inserted into the geared portion of the plastic portion 634.

The protruded portions 639 being inserted into the geared portion are plurally formed spaced apart from each other.

In the outer circumferential surface of the plate portion, a holding unit return spring holding part wherein the one end of a holding unit return spring 631d, which will be described later, is caught in is formed in the shape of a slot.

In the left side of the plate portion, a holding unit 631 is rotatably installed.

The holding unit 631 comprises: an installation plate 631a formed long in length; a holding unit protrusion 631b installed in one side of the installation plate 631a; a holding unit shaft 631c installed in the other side of the installation plate 631a; and a holding unit return spring 631d returning the holding unit protrusion 631b.

The holding unit shaft 631c is installed in the left side of the plate portion.

The holding unit protrusion 631b is formed in the shape of a cylinder, and protruded further rearward than the plate portion. The holding unit protrusion 631b is caught in the protrusion 215, thereby rotating the main latch 200.

The middle portion (coil portion) of the holding unit return spring 631d is inserted into the holding unit shaft 631c, and the one end is installed in the plate portion, and the other end is installed in the holding unit protrusion 631b.

Due to such holding unit 631, the door can be opened manually by pulling out the lever 531 or the cable 800 even when the driving unit 600 fails during closing or after closing of the door through the driving unit 600.

The holding unit 631 plays the role of restricting the main latch 200 to the locking member 300 by rotating the main latch 200 automatically using the driving force of the motor 610 even the door is not completely closed when a user closes the door in ordinary times.

The locking member 300 is rotatably installed inside the housing 100 and locks the main latch 200.

As illustrated in FIG. 9, in the upper side of the locking member 300, a shaft insertion hole 301 wherein the locking member shaft 380 is inserted is penetratingly formed along the front-to-rear direction.

The locking protrusion 310 is formed protrudedly towards the left side in the left lower side of the locking member 300. The upper surface and the lower surface of the locking protrusion 310 are slantly formed, and the width of the locking protrusion 310 is formed to be larger as it travels towards the right.

The locking protrusion 310 is inserted into the locking slot 201 and the auxiliary locking slot 202.

A first unlock link holding element 320 is formed in the right lower side of the locking member 300.

The first unlock link holding element 320 is protrudedly formed towards the front.

A curved pressing portion 330 is formed in the lower side of the locking member 300.

The curved pressing portion 330 is disposed between the first unlock link holding element 320 and the locking protrusion 310.

In the locking member 300, a main latch insertion slot 340 wherein the first surface 203 of the main latch 200 is inserted is formed between the locking protrusion 310 and the curved pressing portion 330.

The lever member 500 is rotatably installed inside the housing 100.

The lever member 500 is disposed between the front side of the inner cover 150 and the rear side of the outer cover 130.

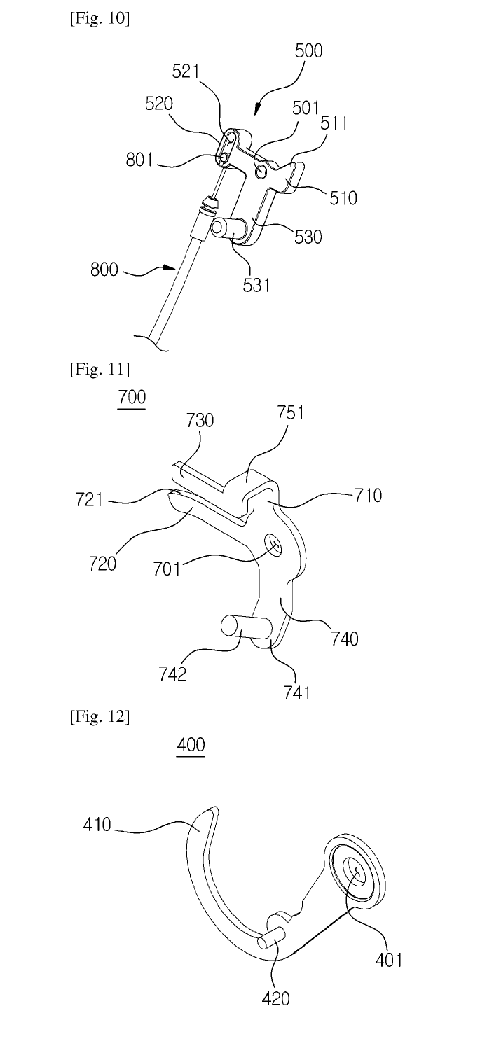

As illustrated in FIG. 10, a shaft insertion hole 501 is penetratingly formed along the front-to-rear direction in the center portion of the lever member 500. A lever member shaft 155 is inserted into the shaft insertion hole 501.

A lever return spring 540 returning the lever member 500 can be further provided. The center portion (coil portion) of the lever return spring 540 is inserted into the lever member shaft 155, and the one end is held by the stopper element 152, and the other end is held by the lever member 500.

In the right side of the lever member 500, a third unlock link holding element 510 is formed protrudedly towards the light.

The upper surface of the third unlock link holding element 510 is slantly formed, and the up-down width thereof is getting larger as it travels towards the right.

In the left side of the lever member 500, a cable installation part 520 is formed protrudedly towards the left.

In the cable installation part 520, an elongated hole 521, wherein a holding protrusion 801 formed in the end of the cable 800 is inserted, is formed. The holding protrusion 801 can be moved within the elongated hole 521. The elongated hole 521 is formed to have an open front. The holding protrusion 801 is formed in the shape of a cylinder disposed along the front-to-rear direction.

The cable 800 can be connected to a lever or a button installed in the vehicle driver's side which is a remote location from the trunk.

In the lower side of the lever member 500, a lever forming portion 530 is downwardly and protrudedly formed.

In the lower side of the lever forming portion 530, a lever 531 is forwardly and protrudedly formed.

When the door latch assembly is installed in the trunk door, the lever 531 is exposed inside or outside of the trunk.

The lever 531 is integrally formed in the lever member 500, and externally exposed through an aperture 133.

Due to this, the lever member 500 is rotated by the lever 531 or the cable 800 connected to the lever member 500.

The third unlock link holding element 510, the cable installation part 520, and the lever forming portion 530 are disposed spaced apart from one another. Thus, the lever member 500 is formed in the shape of letter “T” in general.

As illustrated in FIG. 11, an unlock link 700 releases the locking of the main latch 200 when the lever member 500 is rotated.

The unlock link 700 is rotatably installed inside the housing 100.

The unlock link 700 is disposed between the front side of the bracket 110 and the rear side of the outer cover 130.

In the center area of the unlock link 700, a shaft insertion hole 701 wherein an unlock link shaft 760 is inserted is penetratingly formed along the front-to-rear direction.

In the unlock link 700, a first holding part 710 rotating the locking member 300, a second holding part 720 disposed spaced apart towards the circumferential direction with respect to the first holding part 710, a third holding part 730 caught by the main gear 630, and the fourth holding part 740 being caught by the lever member 500 are formed.

The first holding part 710 is upwardly and protrudedly formed in the upper side of the unlock link 700.

The first holding part 710 is disposed at the left side of the first unlock link holding element 320. The first holding part 710 is caught by the first unlock link holding element 320.

The second holding part 720 is protrudedly formed towards the left in the middle portion of the unlock link 700.

The left end of the second holding part 720 is downwardly and slightly curvedly formed. Thus, in the left end of the second holding part 720, a bended portion 721 is formed.

The second holding part 720 is disposed in the lower side of a second unlock link holding element 420. The second holding part 720 is caught by the second unlock link holding element 420.

The third holding part 730 is formed continuously to the first holding part 710 through a connecting part 751.

The third holding part 730 is disposed along the left-to-right direction, and the connecting portion 751 is disposed along the front-to-rear direction. Thus, the third holding part 730 is disposed further front than the first holding part 710 and the second holding part 720.

The third holding part 730 is disposed above the second holding part 720.

The third holding part 730 is shorter in length than the second holding part 720.

The third holding part 730 is disposed in the upper side of the fourth unlock link holding element 633. The third holding part 730 is caught by the fourth unlock link holding element 633.

The fourth holding part 740 is downwardly and protrudedly formed in the lower side of the unlock link 700.

In the lower portion of the fourth holding part 740, a slanted portion 741 is formed.

In the slanted portion 741, a protruded element 742 protruded towards the front is formed.

The protruded element 742 is disposed in the upper side of the third unlock link holding element 510, thus the protruded element 742 is caught by the third unlock link holding element 510.

The fourth holding part 740 is disposed in the right side of the stopper element 152 so as to prevent the fourth holding part 740 from rotating excessively.

An auxiliary link 400 is rotatably installed inside the housing 100 and being rotated by the second holding part 720.

The left side of the auxiliary link 400 is disposed between the main gear 630 and the main latch 200.

The right side of the auxiliary link 400 is disposed between the locking member 300 and the unlock link 700. That is, the locking member 300 is disposed in the rear side of the auxiliary link 400.

As illustrated in FIG. 12, in the upper right end of the auxiliary link 400, a shaft insertion hole 401 wherein the locking member shaft 380 is inserted is penetratingly formed along the front-to-right direction.

In this way, the rotating axis of the auxiliary link 400 is formed integrally with the locking member shaft 380, which is the rotating axis of the locking member 300, and disposed on the same axial line.

The lower portion of the auxiliary link 400 is curvedly formed towards the left side so as to form a pressing portion 410. Due to such pressing portion 410, the auxiliary link 400 is formed in the shape of letter “J” in general.

In the auxiliary link 400, a second unlock link holding element 420 is formed between the pressing portion 410 and the shaft insertion hole 401. The second unlock link holding element 420 is forwardly and protrudedly formed.

In addition, an auxiliary link return spring 390 returning the auxiliary link 400 is further provided.

One end of the auxiliary link return spring 390 is caught in the second unlock link holding element 420 of the auxiliary link 400, and the other end is caught in the first unlock link holding element 320 of the locking member 300.

The auxiliary link 400 outwardly presses the holding unit 631 through the pressing portion 410 so as to separate the holding unit 631 from the latch 200.

A first sensor 910 detecting the main latch, a second sensor 920 detecting the locking member 300, and a control unit (not shown) controlling the driving unit 600 by using the signals transferred from the first sensor 910, the second sensor 920, and the third sensor 930 are included.

Limit switches can be provided as the first sensor 910, the second sensor 920, and the second sensor 930.

The first sensor 910 and the second sensor 920 are inserted into a sensor receiving slot 151.

The third sensor 930 is inserted into the sensor receiving slot formed in the rear surface of the outer cover 130.

The first sensor 910 is disposed in the lower side of the main latch 200.

The second sensor 920 is disposed in the lower side of the locking member 300.

The third sensor 930 is disposed in the upper side of the plastic portion 634 of the main gear 630.

The third sensor 930 is disposed in front side of the plate portion of the metal portion 642.

The first sensor 910 is pressed by the main latch 200 when the door is closed.

The first sensor 910 detects the main latch 200 when the door is closed.

The second sensor 920 is pressed by the locking member 300 when the door is opened.

The second sensor 920 detects the locking member 300 when the door is opened.

The third sensor 930 is pressed by a sensor pressing portion 637 when the main gear 630 is in the basic position (the position enabling the manual opening of the door through the lever member 500 in an emergency situation).

The third sensor 930 detects the main gear 630 when the main gear 630 is in the basic position.

The control unit rotates the main latch 200 through the driving unit 600 when the first sensor 910 and the second sensor 920 are not detected.

The control unit operates the driving unit 600 until the main latch 200 is detected by the first sensor 910.

Later the control unit reversely rotates the motor 610 until the main gear 630 is detected by the third sensor 930, thereby returning the main gear 630 to its basic position.

Hereinafter, the operation process of a latch assembly for a vehicle trunk door according to the first exemplary embodiment of the present invention having the above described configuration will be described.

<Trunk Door Closing Using a Motor>

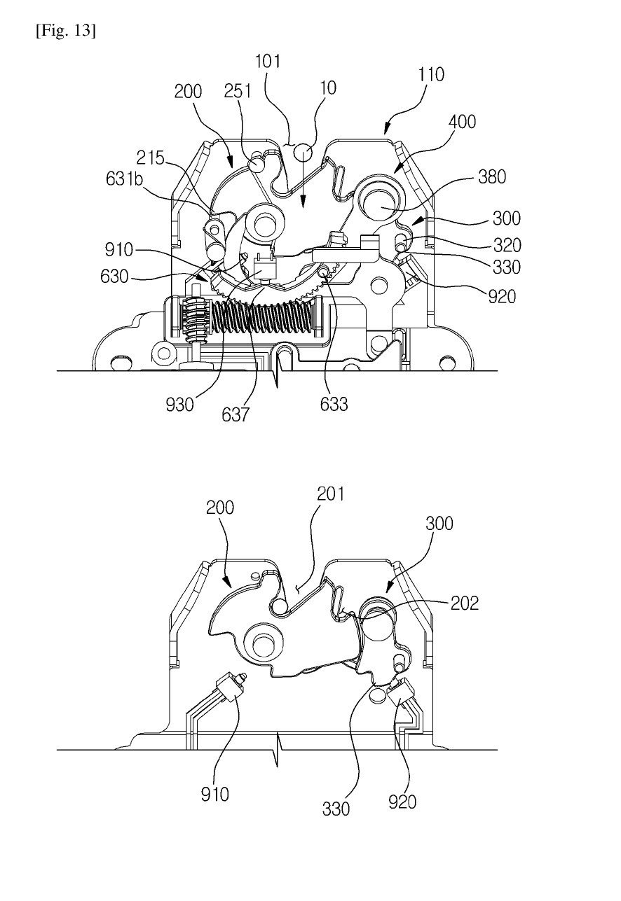

As illustrated in FIG. 13, when the door is opened the locking member 300 presses the second sensor 920. Thus the locking member 300 is detected by the second sensor 920. And, the main latch 200 does not press the first sensor.

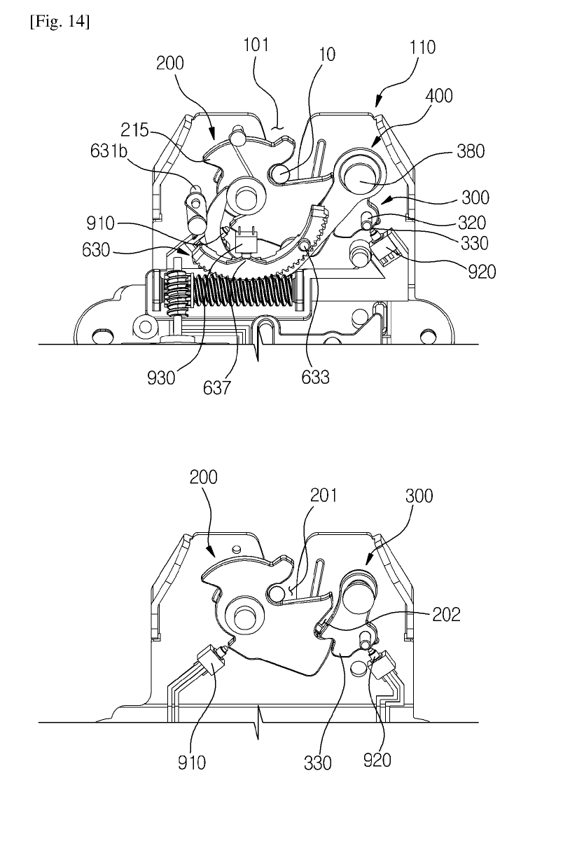

As illustrated in FIG. 14, when a user softly closes the trunk door, which is in an opened state, the latch 200 rotates clockwise since the latch 200 is pressed by the striker 10 installed in the vehicle body.

Due to this action, the locking protrusion 310 is inserted into the auxiliary locking slot 202. Thus, the second sensor 920 is not pressed by the locking member 300.

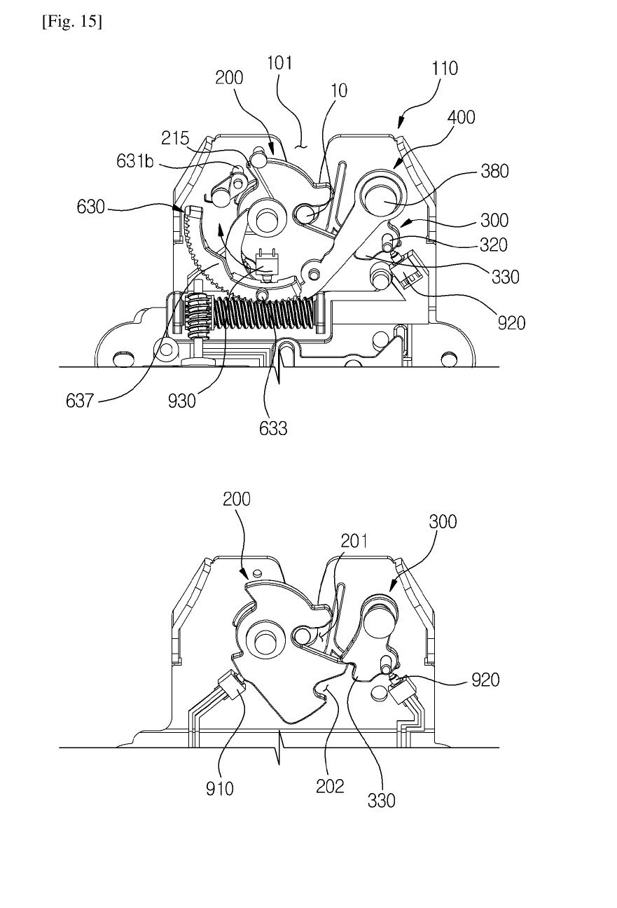

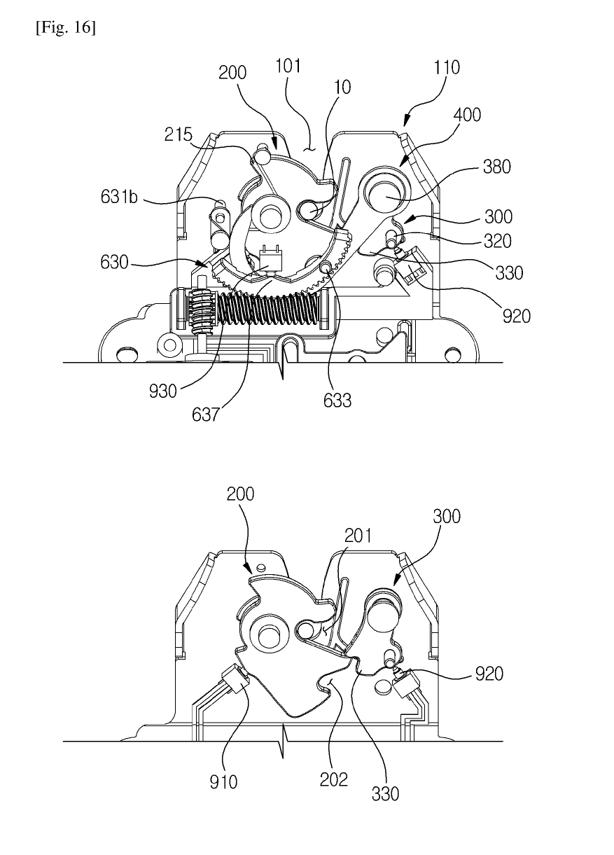

In this way, when the first sensor 910 and the second sensor 920 are not pressed by the main latch 200 and the locking member 300, the control unit rotates the motor 610. As illustrated in FIG. 15, when the motor 610 operates the main gear 630 is also rotated clockwise so that the holding unit protrusion 631b of the holding unit 631 is caught in the protrusion 215. Thus, as the main gear 630 rotates the main latch 200 is also rotated clockwise.

Due to this action, the main latch 200 is rotated further clockwise so that the locking protrusion 310 is caught in the locking slot 201.

In this way, when the locking protrusion 310 is caught in the locking slot 201, the door closing is completed. At this time, the locking member 300 does not press, and the main latch 200 presses the first sensor 910.

The control unit operates the motor 610 until the main latch 200 is detected through the first sensor 910.

Later, as illustrated in FIG. 16, the control unit reversely rotates the motor 610 until the main gear 630 is detected through the third sensor 930 so that the main gear 630 is returned to the basic position.

When trapped inside the trunk or the motor 610 fails, the trunk door can be simply opened manually by manipulating the cable 800 or the lever 531 connected to the inside of the vehicle.

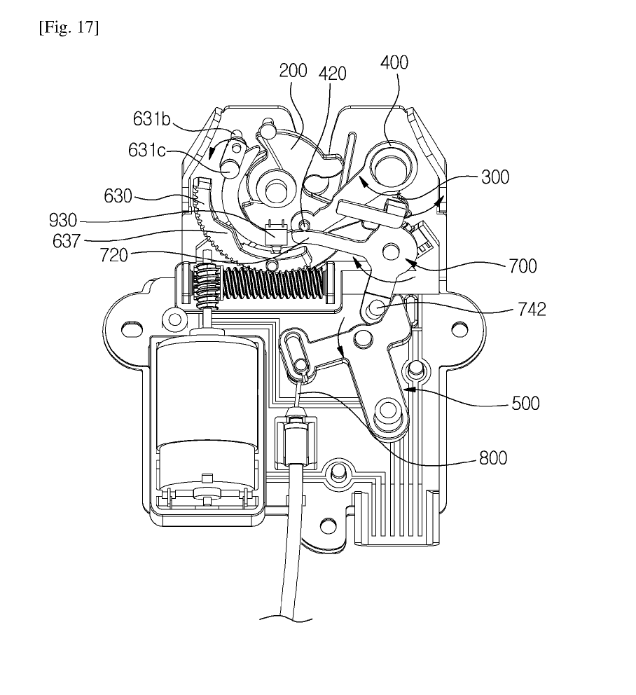

As illustrated in FIG. 17, when the lever 531 or the cable 800 is pulled, the lever member 500 is rotated counterclockwise. The protruded element 742 is caught in the third unlock link holding element 510 of the rotating lever member 500 so that the unlock link 700 is rotated clockwise. The first unlock link holding element 320 of the locking member 300 is caught in the first holding part 710 of the unlock link 700, and the second unlock link holding element 420 of the auxiliary link 400 is caught in the second holding part 720 and rotated clockwise. The locking member 300 is rotated counter clockwise, and the locking protrusion 310 is separated from the locking slot 201. Also, the auxiliary link 400 is rotated clockwise so that the holding unit 631 is rotated counterclockwise, and the holding part protrusion 631b is outwardly moved thereby. Due to this action, the holding unit protrusion 631b is separated from the protrusion 215.

Thus, the main latch 200 is rotated counterclockwise due to the elastic force of the main latch return spring 250. Due to this action, the striker 10 can be separated from the locking slot 201. Thus, the door is opened.

Later, if the lever 531 or the cable 800 is released, the unlock link 700, the lever member 500, and the auxiliary link 400 are returned to the basic position due to the elastic force of the return spring.

<Trunk Door Opening Using a Motor>

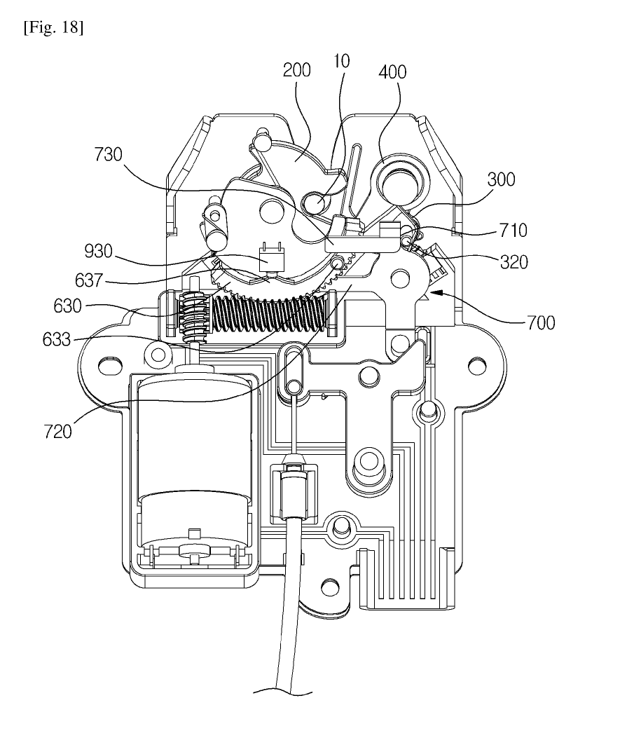

As illustrated in FIG. 18, while the trunk door is closed, if a trunk door opening button is pushed from the inside or outside of the vehicle, the control unit operates the driving unit 600.

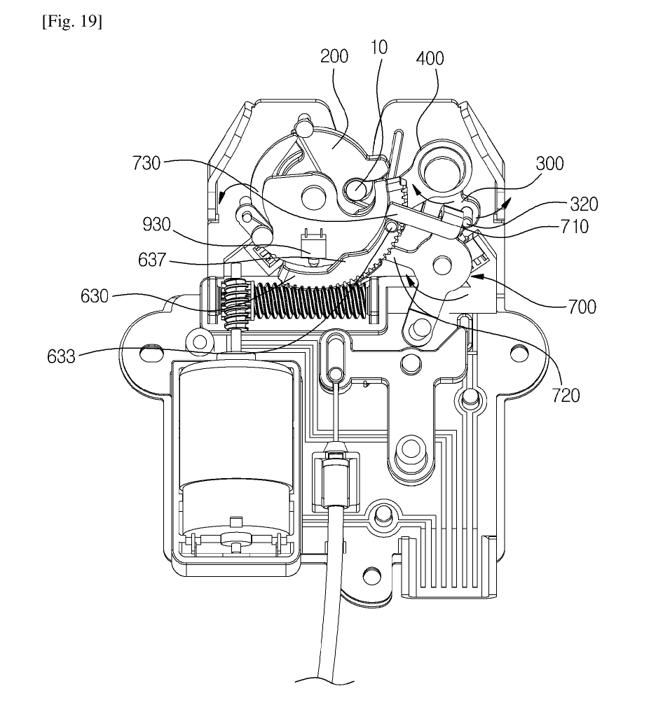

As illustrated in FIG. 19, when the motor 610 is rotated, the main gear 630 is rotated counterclockwise.

When the third holding part 730 of the unlock link 700 is caught in the fourth unlock link holding element 633 of the main gear 630 which is being rotated counter-clockwise, the unlock link 700 is rotated clockwise. The first unlock link holding element 320 of the locking member 300 is caught in the first holding part 710 of the unlock link 700 and rotated counterclockwise, and the second unlock link holding element 420 of the auxiliary link 400 is caught in the in the second holding part 720 and rotated clockwise. The locking member 300 is rotated counterclockwise, and the locking protrusion 310 is separated from the locking slot 201 thereby.

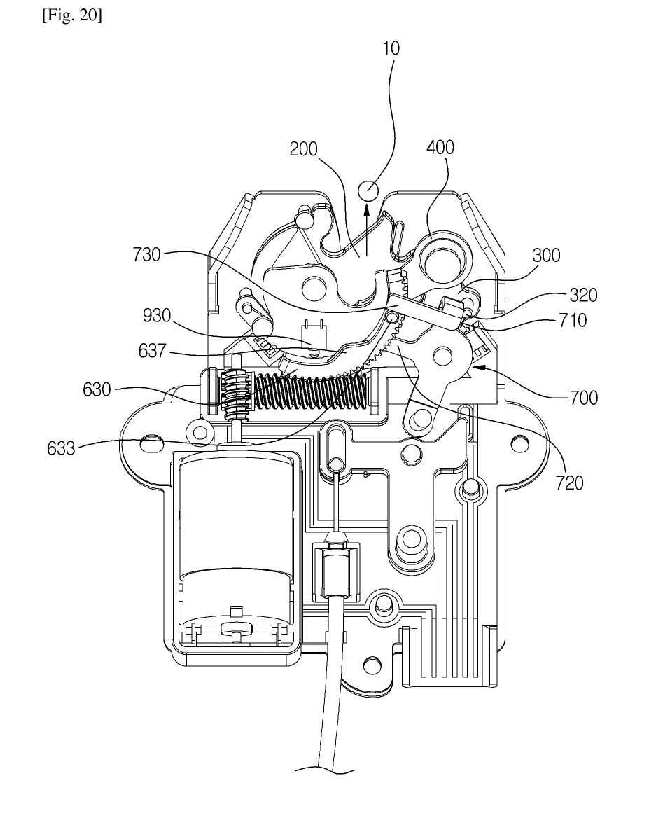

Thus, as illustrated in FIG. 20, the main latch 200 is rotated counterclockwise due to the elastic force of the main latch return spring 250. Due to this action, the striker 10 can be separated from the locking slot 201. Thus, the door is opened.

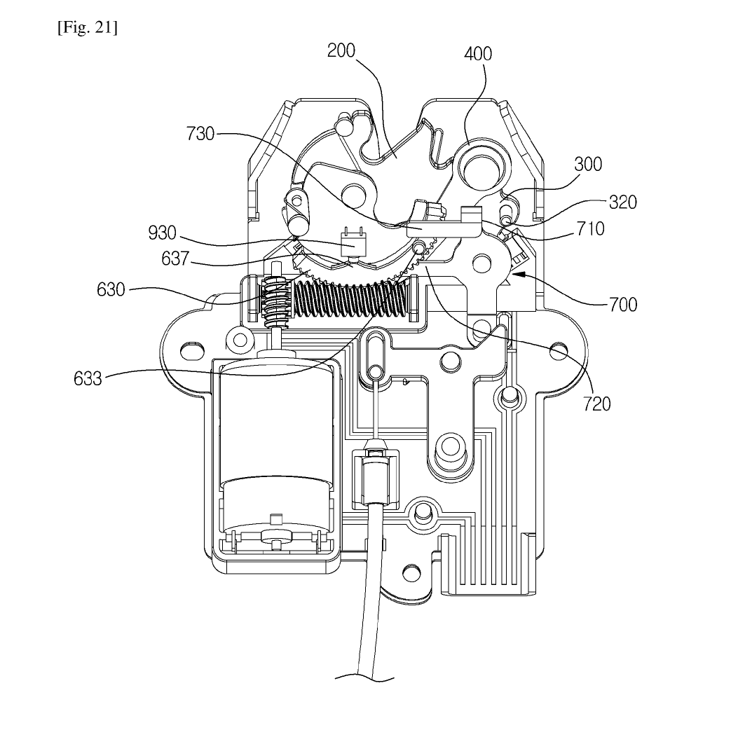

Later, as illustrated in FIG. 21, the control unit reversely rotates the motor 610 until the main gear 630 is detected through the third sensor 930 so that the main gear 630 is returned to the basic position.

In this way, the trunk door can be closed and at the same time the trunk door can be opened through a single driving unit 600.

As described above, although the present invention has been described with reference to the preferred exemplary embodiments, various changes and alterations of the present invention can be made by those skilled in the art without departing from the spirit and the scope of the present invention written in the claims described herein below.

### DESCRIPTION OF SYMBOLS

Description of Numerals for Major Elements in Drawings

10: striker

100: housing, 101: striker insertion slot

102: fastening element

110: bracket

111: bended plate, 112: rear slanted portion

113: first protruded element, 114: second protruded element

115: latch shaft insertion hole

116: unlock link shaft insertion hole

117: locking member shaft insertion hole

118: assembly fastening hole

119: spring holding shaft insertion hole

130: outer cover, 131: front plate

132: side plate, 133: aperture

134: lever member shaft insertion hole, 135: assembly fastening element

150: inner cover, 151: sensor receiving slot

152: stopper element, 153: cable receiving part

154: motor receiving slot, 155: lever member shaft

156: slanted portion

200: main latch, 201: locking slot

202: auxiliary locking slot, 203: first surface

205: second surface, 207: third surface

209: fourth surface, 211: fifth surface

213: spring insertion portion, 215: protrusion

230: latch shaft, 250: main latch return spring

251: main latch spring holding shaft

300: locking member, 301: shaft insertion hole

310: locking protrusion

320: first unlock link holding element

330: curved pressing portion, 340: main latch insertion slot

380: locking member shaft

390: auxiliary link return spring

400: auxiliary link, 401: shaft insertion hole

410: pressing portion

420: second unlock link holding element

500: lever member, 501: shaft insertion hole

510: third unlock link holding element, 511: slanted surface

520: cable installation part, 521: elongated hole

530: lever forming portion, 531: lever

540: lever return spring

600: driving unit, 610: motor

611: first worn, 620: reduction gear

621: first worm gear, 622: second worm

623: shaft supporting plate, 630: main gear

631: holding unit, 631a: installation plate

631b: holding unit protrusion, 631c: holding unit shaft

631d: holding unit return spring, 632: gear teeth

633: fourth unlock link holding element

634: plastic portion

636: shaft insertion hole, 637: sensor pressing portion

639: protruded portion, 642: metal portion

700: unlock link, 701: shaft insertion hole

710: first holding part, 720: second holding part

721: bended portion, 730: third holding part

740: fourth holding part, 741: slanted portion

742: protruded element, 751: connecting part

760: unlock link shaft

800: cable, 801: cable holding protrusion

910: first sensor, 920: second sensor

930: third sensor

1. A latch assembly for a vehicle trunk door characterized in that and comprising:
a housing installed in the trunk door;
a main latch rotatably installed in the housing;
a locking member installed in the housing for locking the main latch; and
a driving unit installed in the housing for closing or opening the trunk door, wherein
the driving unit comprises: a motor; and a main gear being rotated by the motor, and wherein
the rotating axis of the main gear of the driving unit is disposed on the same axial line of the rotating axis of the main latch.

2. The latch assembly for a vehicle trunk door according to claim 1, wherein
the driving unit is capable of closing the trunk door and opening the trunk door.

3. The latch assembly for a vehicle trunk door according to claim 1, wherein
a holding unit rotating the main latch is formed in the main gear.

4. The latch assembly for a vehicle trunk door according to claim 1, wherein
an unlock link wherein a first holding part rotatably installed in the housing for rotating the locking member is further included, and
wherein the locking member is rotatably installed in the housing and the unlock link is rotated by the main gear.

5. The latch assembly for a vehicle trunk door according to claim 3, wherein the locking member is rotatably installed in the housing, and
wherein an unlock link formed with a first holding part rotatably installed in the housing and rotating the locking member and a second holding part disposed spaced apart from the first holding part towards the circumferential direction is further included, and an auxiliary link rotatably installed in the housing and rotated by the second holding part is further include, and
wherein the holding unit is rotatably formed in the main gear, and the auxiliary link separates the holding unit from the main latch, and the unlock link is rotated by the main gear.

6. The latch assembly for a vehicle trunk door according to claim 1, wherein
the motor and the main gear are connected through a first worm, a first worm gear gearing with the first worm, a second worm installed in the first worm gear, and the main gear gearing with the second worm.

7. The latch assembly for a vehicle trunk door according to claim 1, wherein
a third sensor detecting the position of the main gear is further included, and wherein a sensor pressing element pressing the third sensor is formed in the main gear, and the motor is controlled by a control unit using the signal transferred from the third sensor.

8. The latch assembly for a vehicle trunk door according to claim 2, wherein
a holding unit rotating the main latch is formed in the main gear.

9. The latch assembly for a vehicle trunk door according to claim 2, wherein
an unlock link wherein a first holding part rotatably installed in the housing for rotating the locking member is further included, and
wherein the locking member is rotatably installed in the housing and the unlock link is rotated by the main gear.

10. The latch assembly for a vehicle trunk door according to claim 8, wherein the locking member is rotatably installed in the housing, and
wherein an unlock link formed with a first holding part rotatably installed in the housing and rotating the locking member and a second holding part disposed spaced apart from the first holding part towards the circumferential direction is further included, and an auxiliary link rotatably installed in the housing and rotated by the second holding part is further include, and
wherein the holding unit is rotatably formed in the main gear, and the auxiliary link separates the holding unit from the main latch, and the unlock link is rotated by the main gear.

11. The latch assembly for a vehicle trunk door according to claim 2, wherein
the motor and the main gear are connected through a first worm, a first worm gear gearing with the first worm, a second worm installed in the first worm gear, and the main gear gearing with the second worm.

12. The latch assembly for a vehicle trunk door according to claim 2, wherein
a third sensor detecting the position of the main gear is further included, and wherein a sensor pressing element pressing the third sensor is formed in the main gear, and the motor is controlled by a control unit using the signal transferred from the third sensor.
